(19) United States
(12) Patent Application Publication
(10) Pub. No.: US 2020/0211092 A1
(43) Pub. Date: Jul. 2, 2020

(54) ADAPTIVE PRODUCT LISTING USING BLOCKCHAIN INVENTORY AND SMART CONTRACTS

(71) Applicant: PAYPAL, INC., San Jose, CA (US)

(72) Inventor: Pankaj Sarin, Elkhorn, NE (US)

(21) Appl. No.: 16/237,553

(22) Filed: Dec. 31, 2018

(51) Int. Cl. G06Q 30/06; G06Q 10/08; G06Q 20/40; H04L 29/08; H04L 9/06

(52) U.S. Cl. CPC G06Q 30/0637; G06Q 10/087; H04L 9/0637; H04L 67/1042; G06Q 20/405

(57) ABSTRACT

A consortium of marketplaces may be configured to share inventory information via a distributed ledger (blockchain) When an ecommerce marketplace is out of stock of a requested product, the marketplace may provide a seamless experience to a user by searching the inventory of another marketplace rather than alerting the user that the item is out of stock. The marketplace requesting the item may form a smart contract on the distributed ledger with a fulfilment marketplace to govern the terms of the agreement to provide the item to the user on behalf of the requesting marketplace.

### BACKGROUND

The present disclosure generally relates to implementation and use of smart contracts on a distributed blockchain database, and more particularly to a smart contract on a distributed blockchain database to facilitate and enable an adaptive product listing and purchase on an ecommerce marketplace based on user search data.

When an electronic marketplace does not carry an item requested by a user or the item is out of stock, the marketplace can alert the user that the item is out of stock or not carried. Users, however, are more likely to continue their search for the product at other marketplaces when the alert is encountered leaving the site. This can result in fewer sales and an unfulfilling user experience.

Blockchains, also referred to herein as distributed ledgers, are used to track transactions involving crypto currencies (also called virtual currencies) such as, for example, Bitcoin, Litecoin, Ethereum, Monero, and/or other crypto currencies known in the art as well as storage of data. Crypto currency systems provide decentralized digital money that is issued and maintained by distributed software running a network of computing devices, rather than by central banks or public authorities that conventionally issue and control fiat currencies. For example, Bitcoin is a type of decentralized crypto currency that provides for peer-to-peer transactions without an intermediary, with those peer-to-peer transactions verified by Bitcoin network nodes (i.e., the distributed network of computing devices discussed above) and recorded in a public distributed ledger referred to as a blockchain. Crypto currencies like Bitcoin have revolutionized money transfer and payment technology by allowing for censorship resistant, decentralized peer-to-peer transfer of value between users.

Distributed blockchains may also be used for a number of different other technologies besides virtual currency. For instance, Bitcoin and other currency focused networks provide for the execution of a basic “contract” that transfers value between users. However, networks such as the Ethereum network have been created to store executable code (called “smart contracts”) that operates to enforce more complicated relationships with cryptographic software, and extensions to traditionally currency-centric blockchains such as the Bitcoin network have proposed similar enhanced functionality as well. For example, such smart contracts may monitor for conditions defined in the smart contract and, when a condition is determined to be present, the code may be executed and provide an output. As such, smart contracts allow two or more parties to perform more relatively complex transactions in a decentralized, self-executing, self-enforceable manner to provide irreversible transactions that can be tracked on a blockchain and without the need for an intermediary.

### BRIEF DESCRIPTION OF THE FIGURES

FIG. 1 is a schematic view illustrating an embodiment of a networked system for providing an adaptive product listing;

FIG. 2 is a schematic view illustrating an embodiment of an electronic coin;

FIG. 3 is a schematic view illustrating an embodiment of a distributed ledger;

FIG. 4 is a schematic view illustrating an embodiment of an adaptive product listing system;

FIG. 5 is a flow chart illustrating an embodiment of a method for providing an adaptive product listing using smart contracts;

FIG. 6 is a flow chart illustrating an embodiment of a method for providing an adaptive product listing;

FIG. 7 is a perspective view illustrating an embodiment of a user device; and

FIG. 8 is a schematic view illustrating an embodiment of a computer system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Embodiments of the present disclosure include systems and methods for unaffiliated marketplaces to share inventories and place orders on behalf of users using blockchains, providing a seamless user experience when the marketplace does not carry or is out of stock of the requested item. In some embodiments, marketplaces may share inventories using a distributed ledger, also referred to as a blockchain or distributed blockchain database, and use a smart contract stored and executed on a distributed ledger to memorialize the agreement between marketplaces, automatically change inventories, and/or transfer funds between the marketplaces (and user). The use of smart contracts and a distributed ledger allows for the transactions between the unaffiliated marketplaces to be verified and executed automatically. The use of the blockchain may allow transactions to be verified by the marketplaces, third parties, and the user. Use of the blockchain may also automate movement of funds when using a crypto currency.

In an embodiment, a user may be interested in a product on a marketplace. The user may search for the product on the marketplace's ecommerce platform. The product may be out of inventory on the selected marketplace but available in another marketplace instead. There is an opportunity for the marketplace to dynamically load the product listing on the ecommerce platform using information from a fulfilment marketplace. The requesting marketplace may route the user's search to a blockchain (e.g., a consortium blockchain) to search an inventory of one or more marketplaces. The consortium (and thus access to the consortium blockchain) may include a variety of marketplaces, e.g., Amazon, AliExpress, eBay, and Etsy. Different consortium members may have different permissions for interacting with the block chain, e.g., read-only or read-write. Joining the consortium may be automatic or may be controlled. The requesting marketplace and fulfilment marketplace may negotiate terms of a smart contract to perform the transaction. The product then may appear in the requesting marketplace, without requiring the user to go to or search the fulfilment marketplace directly, and generate an interface for the user to purchase the item. In an embodiment, the fulfilment marketplace may be the manufacturer of the item.

In certain embodiments, when the user places the order with the requesting marketplace, the requesting marketplace will execute the smart contract with the fulfilment marketplace. In other embodiments, the smart contract is executed prior to the user placing the order, where the product is loaned or held for the requesting marketplace for a period of time should the user choose to place the order. When the user places the order with the requesting marketplace, the fulfilment marketplace can place the final order and share order metadata (e.g., shipping details) with the requesting marketplace.

In other embodiments, the requesting marketplace server may send a broadcast through a mediating server to one or more potential fulfilment marketplaces. The mediating server may process responses from the potential fulfilment marketplaces and send a response to the requesting marketplace. Using an active token session or token exchange, the mediating server may route a placed order request and process a completed order to send from the fulfillment marketplace server to the requesting marketplace server. The token session may orchestrate the interaction between the requesting and fulfilment marketplace servers. Tokens may include an identifier to for a request, a state variable used to determine whether the transaction is active, whether it was declined. The tokens may also include standard terms for the agreement. Use of the token session may protect user privacy. Verification during the token session may allow for user data (identity information, payment data such as account numbers) to be shielded from the fulfilment marketplace. In certain embodiments, shipping information is shared with the fulfilment marketplace.

In some embodiments, website and/or webpage technology may be enhanced to provide a generated interface based on current inventory levels of a product based on a user query. An interface can be generated that is based on inventory availability at other marketplaces based on a real-time agreement (e.g. in response to a user search) between marketplaces.

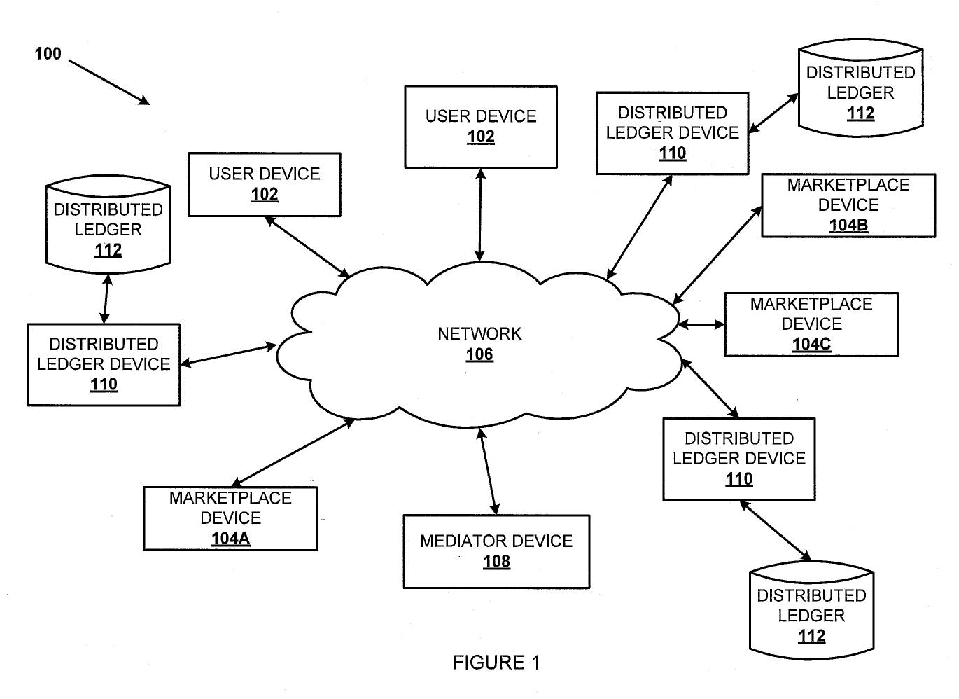

Referring now to FIG. 1, an embodiment of a networked system 100 is illustrated. The networked system 100 includes a plurality of user devices 102 and a plurality of marketplace devices 104A-C in communication over network 106. Also connected to network 106 is mediator device 108 and a plurality of distributed ledger devices 110 connected to a (copy of) distributed ledger 112. However, the embodiments herein are meant to be merely exemplary, and one of skill in the art in possession of the present disclosure will recognize that a wide variety of system providers may operate, alone or together, to provide the systems and methods discussed herein without departing from the scope of the present disclosure.

The user devices 102, marketplace devices 104A-C, mediator device 108, distributed ledger devices 110, and/or distributed ledger 112 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 100, and/or accessible over the network 106.

The network 106 may be implemented as a single network or a combination of multiple networks. For example, in various embodiments, the network 106 may include the Internet and/or one or more intranets, landline networks, wireless networks, and/or other appropriate types of networks.

The user devices 102 may be implemented using any appropriate combination of hardware and/or software configured for wired and/or wireless communication over network 106. For example, in one embodiment, the user devices 102 may be implemented as a personal computer of a user in communication with the Internet. In other embodiments, the user devices 102 may be a smart phone, wearable computing device, laptop computer, and/or other types of computing devices.

The user devices 102 may include one or more browser applications which may be used, for example, to provide a convenient interface to permit the user to browse information available over the network 108. For example, in one embodiment, the browser application may be implemented as a web browser configured to view information available over the Internet. In one embodiment, user devices 102 may be able to connect to an electronic commerce interface of marketplace devices 104. The electronic commerce interface may include a storefront where a user of user devices 102 may browse, search, and purchase different products. In one embodiment, a user may search for a product not currently in stock in the inventory of marketplace device 104A using the ecommerce interface of marketplace device 104A. Marketplace device 104A, rather than displaying an out of stock message or an error message, may search through the inventories of other marketplace devices (e.g., marketplace device 104B and 104C) and determine whether the product is in-stock in these marketplaces. The search may involve one or more of mediator device 108 and distributed ledger devices 110. If the product is in-stock at one or more of those marketplaces, marketplace device 104A can negotiate with the other marketplace device 104B or 104C to ship the product on behalf of marketplace device 104A.

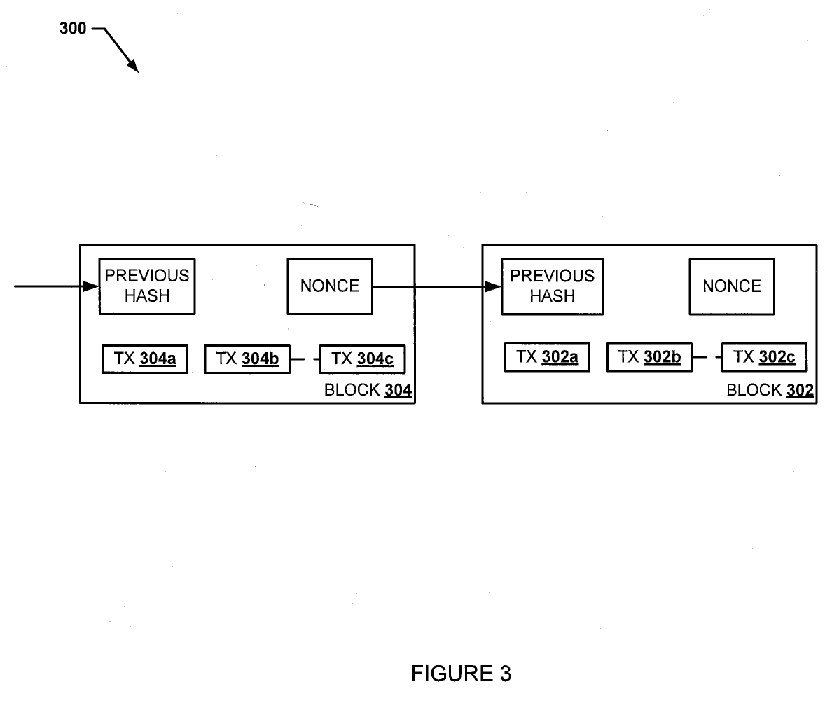

In the illustrated embodiment, system 100 may also include distributed ledger device(s) 110 that are coupled to a distributed ledger 112, which may be stored in a transactional database, and the network 106. The distributed ledger device(s) 110 may operate to receive product inventory information at a marketplace and/or receive virtual transactions broadcast by the marketplace devices 104 and user devices 102, confirm those transactions, and generate/maintain a distributed ledger 112 (e.g., a public, private, or consortium blockchain stored on each of those devices) discussed below with reference to FIG. 3. For example, distributed ledger devices 110 may operate to generate (a k a. “mine”) crypto currency while creating a distributed ledger (also referred to as a blockchain), and maintain the distributed ledger while performing other functions detailed herein. The distributed ledger described herein may be a public, private, or consortium distributed ledger or a combination of multiple types. For example, smart contracts may be stored and executed on a public blockchain, but then later that information is copied to a consortium blockchain, for example, for ease of searching. Further still, while illustrated in FIG. 1 and discussed in some embodiments below as operating separately to perform separate functions, in some embodiments, the functionality of a the marketplace device(s) 104 or mediator device 108 and the distributed ledger device(s) 110 may be combined such that computing devices in a distributed network operate to maintain a distributed ledger while also operating to provide an ecommerce platform or acting as a mediator between marketplaces as discussed below. Thus, while a specific embodiment has been illustrated, one of skill in the art in possession of the present disclosure will appreciate that system 100 illustrated in FIG. 1 may include a variety of modification while remaining within the scope of the present disclosure.

The user devices 102 may also include one or more toolbar applications which may be used, for example, to provide user-side processing for performing desired tasks in response to operations selected by the user. In one embodiment, the toolbar application may display a user interface in connection with the browser application.

The user devices 102 may further include other applications as may be desired in particular embodiments to provide desired features to the user devices 102. In particular, the other applications may include a payment application for payments processed by a payment service provider. The other applications may also include security applications for implementing user-side security features, programmatic user applications for interfacing with appropriate application programming interfaces (APIs) over the network 106, or other types of applications. Email and/or text applications may also be included, which allow the user to send and receive emails and/or text messages through the network 106. The user devices 102 may include one or more user and/or device identifiers which may be implemented, for example, as operating system registry entries, cookies associated with the browser application, identifiers associated with hardware of the user devices 102, or other appropriate identifiers, such as a phone number.

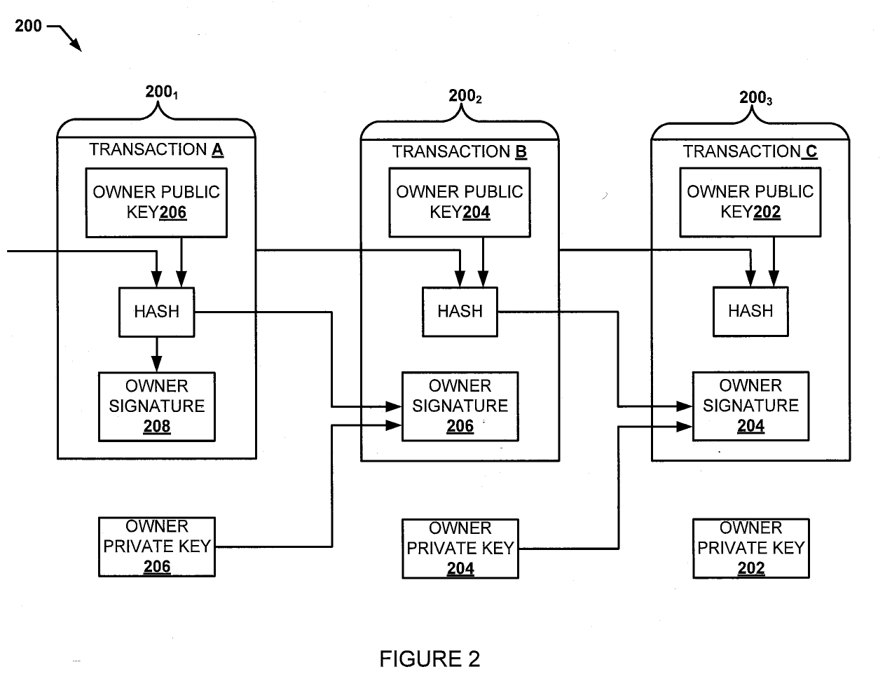

Referring now to FIG. 2, an embodiment of an electronic coin 200 is illustrated and described briefly for reference in the discussion below. While the examples of the electronic coin 200 and the blockchain 300 of FIG. 3 describe the basics of electronic coins and blockchains utilized to record currency transactions, electronic coins and blockchains may be used for recording and/or tracking a variety of other information such as credit information, identity information, medical information, education information, other personal user information, shipment information, food traceability, property ownership, and/or any other data suitable for recording and/or tracking.

In the embodiment illustrated in FIG. 2, a virtual currency system associated with the present disclosure may define an electronic coin as a chain of digital signatures provided by previous owners of the electronic coin to subsequent owners of the electronic coin. In the illustrated embodiment, the electronic coin 200 is owned by an owner 202, and FIG. 2 illustrates how the electronic coin 200 is defined by the digital signatures of previous owners 204, 206, and 208. Specifically, in transaction A, a hash value of the public key of owner 206 (i.e., the owner receiving, as a result of transaction A, an electronic coin 2001 defined by digital signatures provided up to transaction A) and the previous transaction (not illustrated, but occurring prior to transaction A) was signed by owner 208 (i.e., the owner providing, as a result of transaction A, the electronic coin 2001 defined by digital signatures provided up to transaction A) using a private key and added to an initial electronic coin (which was defined by digital signatures provided up to the transaction prior to transaction A) such that the electronic coin 2001 was transferred to owner 206.

Similarly, in transaction B, a hash value of the public key of owner 204 (i.e., the owner receiving, as a result of transaction B, an electronic coin 200₂ defined by digital signatures provided up to transaction B) and transaction A was signed by owner 206 using a private key and added to the electronic coin 2001 such that the electronic coin 200₂ was transferred to owner 204. Similarly, in transaction C, a hash value of the public key of owner 202 (i.e., the owner receiving, as a result of transaction C, the electronic coin 200 defined by digital signatures provided up to transaction C) and the transaction B was signed by owner 204 using a private key and added to the electronic coin 200₂ such that the electronic coin 200 was transferred to owner 202. Any payee receiving an electronic coin (e.g., owner 206 in transaction A, owner 204 in transaction B, and owner 202 in transaction C) can verify the signatures to verify the chain of ownership of the electronic coin. In the discussion below, it should be understood that the term “electronic coin(s)” may be used to encompass any amount or type of electronic coins or virtual/electronic currency, from fractions of a coin (e.g., 0.00564500 electronic coins) to many multiples of coins (e.g., 56,000.00000000 electronic coins).

Referring now to FIG. 3, an embodiment of a distributed ledger 300 is illustrated and described briefly for reference in the discussion below. As discussed above, the distributed ledger 300 may operate to verify that payers transferring an electronic coin (e.g., referring back to FIG. 2, owner 206 in transaction A, owner 204 in transaction B, and owner 202 in transaction C) did not “double-spend” (e.g., use a private key to sign any previous transactions involving) that electronic coin. To produce the distributed ledger 300, a distributed network of devices operates to agree on a single history of transactions in the order in which they were received such that it may be determined that a transaction between a payer and a payee using an electronic coin is the first transaction associated with that electronic coin. Each device in the distributed network operates to collect new transactions into a block, and then to increment a proof-of work system that includes determining a value that when hashed with the block provides a required number of zero bits.

For example, for a block 302 that includes a plurality of transactions 302a, 302b, and up to 302c, a device in the distributed network may increment a nonce in the block 302 until a value is found that gives a hash value of the block 302 the required number of zero bits. The device may then “chain” the block 302 to the previous block 304 (which may have been “chained” to a previous block, not illustrated, in the same manner). When devices in the distributed network find the proof-of-work for a block, that block (e.g., block 302) is broadcast to the distributed network, and other devices in the distributed network will accept that block if all the transactions in it are valid and not already spent (which may be determined by creating the next block using the hash value of the accepted block 302). The distributed network will always consider the longest chain of blocks to be the correct one and will operate to continue to extend it. If a device receives two different versions of a block, it will work on the first block received, but save the second block received in case the branch of the chain that includes the second block becomes longer (at which point that device will switch to working on the branch of the chain that includes the second block).

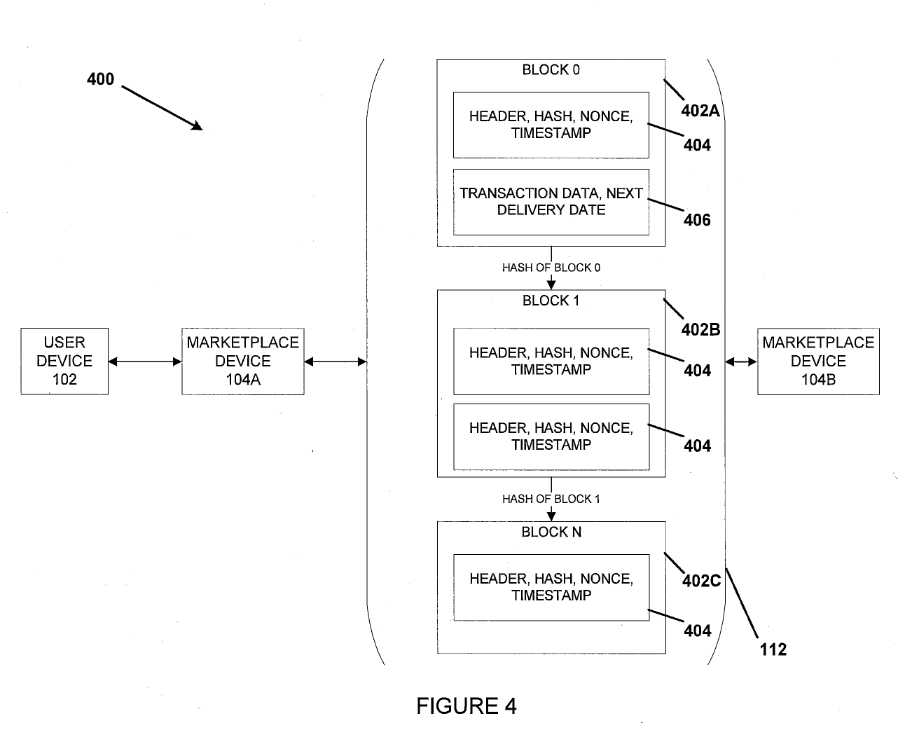

Referring now to FIG. 4, a conceptual diagram of exemplary system 400 is illustrated that, in some embodiments, may be used to update an inventory and provide an adaptive product listing to the user device 102 using a blockchain based inventory and smart contracts. However, the foregoing system may be provided by any of a variety of computing devices such as desktop computing systems, laptop/notebook computing systems, tablet computing systems, mobile phones, Application Specific Integrated Circuit (ASIC) computing systems, and/or other computing device known in the art, as well as multiple varieties of blockchain technologies (as well as splitting up the blocks into distinct chains for different types of blocks) while remaining within the scope of the present disclosure.

A marketplace device 104B may update an inventory record, including a current inventory amount for a product, on a distributed ledger 112. The update of the inventory record may be done directly (the marketplace device 104B adds a block to the blockchain) or indirectly (e.g., using an intermediary “mining” device). User device 102 may query marketplace device 104A for an item. Marketplace device 104A may determine that the item is unavailable and route the request to a blockchain, e.g., a consortium blockchain with a plurality of marketplace members (e.g., marketplace device 104A-C). The consortium blockchain may be used as a layer to exchange and share data between consortium subscribers. The consortium subscribers may choose to update inventory feeds based on a pre-configured timeframe or an agreed time frame (e.g. all subscribers to the consortium blockchain provide an update to their category product inventory every 5 minutes or based on a time cycle). In some embodiments, the consortium blockchain is integrated with a public blockchain. The data held in the consortium blockchain may be a copy of what is held in a public ledger blockchain but contains fewer blocks/transactions because the consortium blockchain contains only consortium specific data. In certain embodiments, the consortium blockchain includes data not included in the public blockchain. In some exemplary embodiments, marketplace device 104A may query an API with item details including a token identifier and/or marketplace name/identifier to authenticate and verify the identity of the marketplace device 104A. Additional API parameters may include the marketplace name, product information including the name or SKU, user authentication information, public key of the user, shipping address to send the order, the type of device that user device is using to query for the product (e.g. mobile app, web, mobile web), primary currency of the order (USD, Euro, bitcoin, Ethereum), and a shipping timespan requirement, e.g., whether there is a shortest shipping timespan required for the order and what that timespan requirement is. The API may be used to authenticate and verify parties to the transaction including marketplace device 104A and marketplace device 104B. The API may be used to send a request from the marketplace device 104A to distributed ledger 112 or a mediating device 108/distributed ledger device 110 that can query the distributed ledger 112 and respond to API queries from marketplace devices 104.) In an embodiment using mediating device 108 acting as a gateway to the fulfilment marketplace device 104A, data transformation and optimization may be performed on the query. The distributed ledger 112 (or mediating device 108/distributed ledger device 110) may respond to the query with information associated with a marketplace where the product is available (e.g., marketplace device 104B). A smart contract may be created with terms defined. These terms may include the fulfilment marketplace device, item description (name, SKU), shipping address, shipping timeframe/speed, primary currency, shipping cost, product return time period, and a profit margin share. Therefore, rather than responding that an item was not found based on a user query, a marketplace can respond with an offered item with price/delivery/and other information already calculated being governed by a smart contract. Terms of the smart contract may be standardized or may be based on the product, product location, or shipping location. In an embodiment, machine learning may be used to negotiate the terms of the contract between the requesting marketplace device 104A and fulfilment marketplace device 104B.

Distributed ledger 112 may include a plurality of blocks 402A-C. Each block 402 may contain one or more individual transactions 404 and 406. Different types of transactions may be found within an individual block. In other embodiments, different transactions are segregated to separate blocks. Certain transactions (e.g., transactions 404) may contain inventory information regarding one or more products at a marketplace. These transactions will have header information, a hash, nonce, and a timestamp. Other transactions (e.g., transaction 406) may include transaction metadata from a smart contract stored in distributed ledger 112. Transaction 406 may include transaction data and next delivery date information.

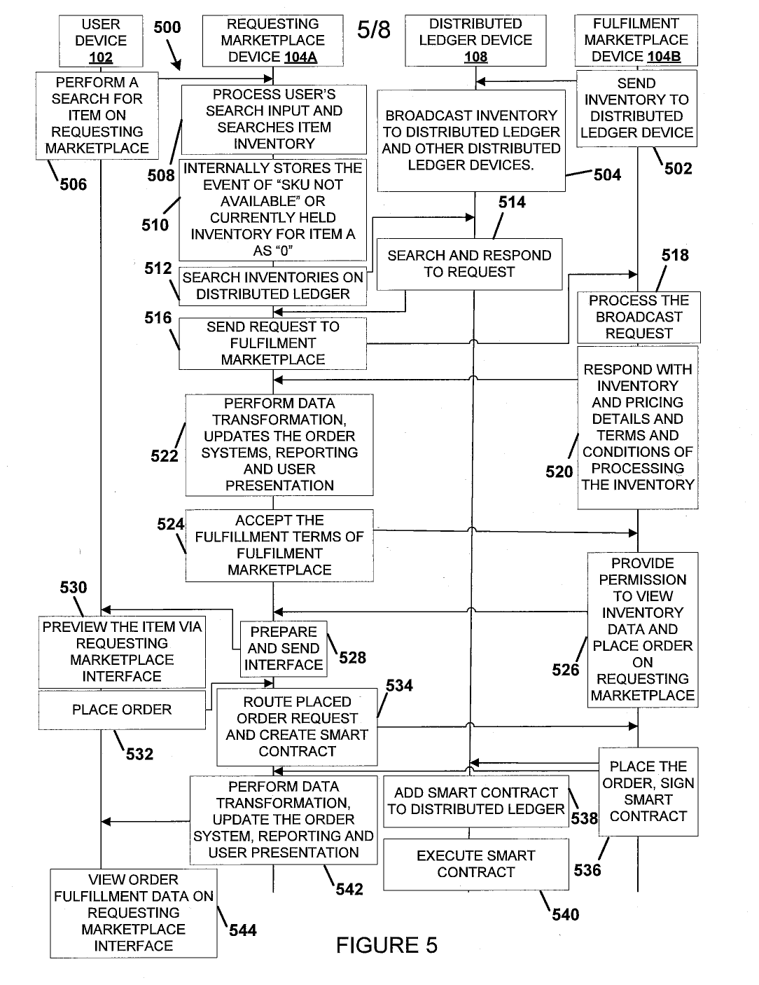

Referring now to FIG. 5, the method 500 begins at block 502 where marketplaces, such as fulfilment marketplace device 104B, may share their inventory with others in a consortium by sending inventory to a distributed ledger device 110 for inclusion in a blockchain. The inventory listing may be a listing of SKUs and a number of the item available. In further embodiments, sale price of the item is also included in the inventory listing. At block 504, distributed ledger device 110 may broadcast the inventory to the distributed ledger 112 and other distributed ledger devices 110.

A user using the user device 102 may perform a search for an item on an ecommerce platform of a marketplace, such as through requesting marketplace device 104A. The user device 102 may send a search request, at block 506, to the marketplace device 104A searching for a product. The search request may include the name of the item, a SKU, or a description of the item. In an example, the user device 102 may provide a hypertext markup language (HTML) request to receive a webpage, and the HTML request may include a user device identifier for the user device 102 such as a phone number, an internet protocol (IP) address, a media access control (MAC) address, and/or any other user device identifier and/or user identifier. If the item is in the inventory, requesting marketplace device 104A may provide an interface on the ecommerce platform with details from the inventory to user device 102. The requesting marketplace device 104A may process the search input of the user device 102 and search the inventory of the marketplace device 104A, at block 508. The marketplace device 104A may determine that the product searched for by user device 102 is out of stock or not carried by the marketplace device 104A. The marketplace device 104A may store the event of “Stock-Keeping Unit (SKU) not available” or currently held inventory for the item as “0,” at block 510.

Rather than delivering an error to user device 102 alerting the user device 102 the searched for product is unavailable, the requesting marketplace device 104A may search inventories of other marketplaces, such as the fulfilment marketplace 104B, at block 512. In an embodiment, marketplace device 104A may search the inventories of other marketplaces, e.g., marketplace device 104B and 104C, to offer varied different pricing, shipping, or other options to the user device 102.

Marketplace device 104A may query a distributed ledger device 110 to search the inventories on the distributed ledger 112. Distributed ledger device 110 may search the inventories on inventories on the distributed ledger 112 and respond with one or more marketplace device where the product is available, at block 514, to the requesting marketplace device 104A. For example, the following format may be returned to the requesting marketplace device 104A when marketplace device 104A queries the distributed ledger 112:

<<SKU ###_Quantity_NAME>>

For example, the listing may include “SKU123_30_iPHONE3GS”. This data may be parsed by the requesting marketplace device 104A to draw inferences that iPhone 3GS is available at the fulfilment marketplace server 104B and has 30 units available at the time of query.

Requesting marketplace device 104A may create a secure session with the fulfillment marketplace device 104B using one or more secure tokens. At block 516, the requesting marketplace device 104A may send a request to the fulfilment marketplace device 104B to fill an order for the item requested by user device 102. A secure token session may be used to structure the request. In an embodiment, requesting marketplace device 104A may send the request to multiple marketplaces using multiple secure sessions. A token system may be used to arbitrate and differentiate responses from multiple (potential) fulfilment marketplace devices. In certain embodiments, if a fulfilment marketplace device accepts all the terms from a requesting marketplace device 104A (including e.g., two-day delivery with no conditions), this fulfilment marketplace device 104B may be selected automatically. In such an instance, arbitration and use of a token system may be bypassed.

Fulfilment marketplace device 104B may process the fulfilment request, at block 518. If the fulfilment marketplace device 104B has the item in its inventory, at block 520, the fulfilment marketplace 104B may respond with inventory and pricing details and additional terms and conditions for processing the item to the mediating device 108. The additional terms and conditions may include differing terms from those set forth in an item request. In certain embodiments, the fulfilment marketplace device 104B generates the smart contract (signed by fulfilment marketplace device 104B) by sending the terms and conditions to the requesting marketplace device 104A which the requesting marketplace device 104A can sign with a private key. In other embodiments, the smart contract is generated by the requesting marketplace device 104A after the user device 102 places the order for the product (signed by the requesting marketplace device 104A), where it is countersigned by the fulfilment marketplace device 104B when it receives the acceptance.

At block 522, the requesting marketplace device 104A may perform data transformation on the received data, update its order systems, reporting, and provide a user presentation based on the received terms and conditions. If the requesting marketplace device 104A accepts the terms offered for the item from the fulfilment marketplace device 104B, at block 524, the requesting marketplace device 104A may send an acceptance message accepting the fulfilment terms of the fulfilment marketplace device 104B to the mediating device 108. This may include an acceptance of changed terms from the initial request made by the requesting marketplace device 104A. Upon receipt of the acceptance, fulfilment marketplace device 104B, at block 526, may provide permission for user device 102 to view the inventory data and place the order using the ecommerce platform of the requesting marketplace device 104A. This permission to view inventory data by the user device 102 may be cached by the fulfilment marketplace device 104 including the fulfilment terms provided. The data may be stored for a set period of time (e.g., one hour, one day, one week) or until an order is placed.

The requesting marketplace device 104A may prepare and send an interface to user device 102 with an item preview, at block 528, to the user device 102. In one embodiment, the interface does not inform the user device 102 that the item will be shipped by the fulfilment marketplace device 104B. In another embodiment, the interface includes a note alerting user device 102 that a third-party seller will be shipping the item. At block 530, the user device 102 may preview the item via the interface received from the requesting marketplace device 104A.

If the user of user device 102 wishes to place the order, the user may direct user device 102 to place an order for the item using the interface received from requesting marketplace device 104A, at block 532. Requesting marketplace device 104A routes the placed order request to the fulfilment marketplace device 104B using an active session token, at block 534. The placed order request may include the creation of a smart contract. The terms in the smart contract may include the fulfilment marketplace device information, item description (name, SKU), shipping address, shipping timeframe/speed, primary currency, shipping cost, product return time period, and a profit margin share. The smart contract may be signed using the private key of the requesting marketplace device 104A.

The fulfilment marketplace device 104B may sign the smart contract using its private key and place the order, at block 536. The fulfilment marketplace device 104B may send order metadata to the requesting marketplace device. The smart contract may be placed on the distributed ledger 112 by distributed ledger device 110, at block 538. At block 540, the smart contract may be executed by the distributed ledger device 110. Execution of the smart contract may update inventory information associated with the item on the distributed ledger 112. Additionally, execution of the smart contract may automatically send updates of the shipment and delivery process, based on an API call from a delivery service. Execution of the smart contract may create transaction entries in distributed ledger 112 to effectuate a funds transfer or transaction among the parties involved in the smart contract. Smart contract execution may or may not trigger notification services to inform the informed parties (e.g. requesting marketplace device 104A, fulfilment marketplace device 104B, user device 102).

At block 542, the requesting marketplace device 104A may perform data transformation, update the order system, reporting, and generate a user interface to indicate that the order has been placed. The user interface may include order details including a confirmation number. At block 544, the user device 102 may view order fulfilment data on the user interface provided by the requesting marketplace device 104A.

Fulfilment marketplace device 104B may then process the order for shipment. Shipping and package tracking information, e.g., a tracking identifier, may be sent to the requesting marketplace device 104A and/or updated on the smart contract on the distributed ledger 112 (via distributed ledger device 110) and subsequently user device 102 when the ordered item is shipped.

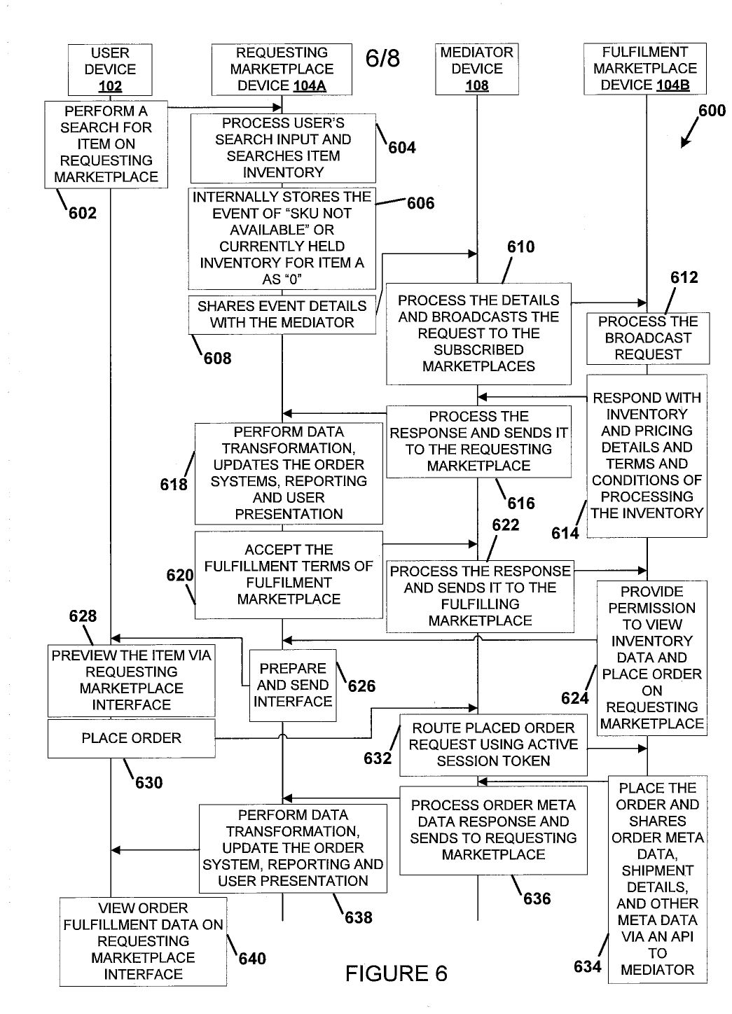

Referring now to FIG. 6, the method 600 begins at block 602 where a user device 102 performs a search for an item on an ecommerce platform of a marketplace device 104A. At block 604, requesting marketplace device 104A may process the search input of user device 102 and search the inventory of the requesting marketplace device 104A for the item. The search request may include the name of the item, a SKU, or a description of the item. In an example, the user device 102 may provide a hypertext markup language (HTML) request to receive a webpage, and the HTML request may include a user device identifier for the user device 102 such as a phone number, an internet protocol (IP) address, a media access control (MAC) address, and/or any other user device identifier and/or user identifier. If the item is in the inventory, requesting marketplace device 104A may provide an interface on the ecommerce platform with details from the inventory to user device 102. If the item is not in the inventory, at block 606, requesting marketplace device 104A may internally store the event of “SKU not available” or the currently held inventory for the item is “0.” Requesting marketplace device 104A, at block 608, may share the event details with mediator device 108 to request whether any other marketplace (e.g. fulfilment marketplace device 104B) has the item in its inventory. Mediator device 108, at block 610, may process the event details and broadcast the request to other marketplace devices 104B and 104C. Fulfilment marketplace device 104B may process the broadcast request, at block 612. In an embodiment, several marketplaces may process and respond to the broadcast request. A token system may be used to arbitrate and differentiate responses from multiple (potential) fulfilment marketplace devices. In certain embodiments, if a fulfilment marketplace device is able to accept all the terms from a requesting marketplace device 104A (including e.g., two-day delivery with no conditions), this fulfilment marketplace device 104B may be selected automatically. In such an instance, arbitration and use of a token system may be bypassed. If the fulfilment marketplace device 104B has the item in its inventory, at block 614, the fulfilment marketplace device 104B may respond with inventory and pricing details and additional terms and conditions for processing the item to the mediating device 108. The additional terms and conditions may include differing terms from those set forth in an item request. For example, if the shipping timeframe the fulfilment marketplace device 104B can provide is five days whereas two days guaranteed was requested by the requesting device or if the payment is offered using a two-day issuance of payment compared to immediate payment via VISA or MASTERCARD tokens or a cryptocurrency. Mediating device 108 may process the response from the fulfilment marketplace device 104B and send it to the requesting marketplace device 104A, at block 616.

At block 618, the requesting marketplace device 104A may perform data transformation on the received data, update its order systems, reporting, and generate/provide a user presentation. If the requesting marketplace device 104A accepts the terms offered for the item from the fulfilment marketplace device 104B, at block 620, the requesting marketplace device 104A may send an acceptance message accepting the fulfilment terms of the fulfilment marketplace device 104B to the mediating device 108. This may include an acceptance of changed terms from the initial request made by the requesting marketplace device 104A. Mediating device 108, at block 622, may process the acceptance message and send it to the fulfilment marketplace device 104B. Upon receipt of the acceptance, fulfilment marketplace device 104B, at block 624 may provide permission for user device 102 to view the inventory data and place the order using the ecommerce platform of the requesting marketplace device 104A. The requesting marketplace device 104A may prepare and send an interface to user device 102 with an item preview, at block 626, to the user device 102. In one embodiment, the interface does not inform the user device 102 that the item will be shipped by the fulfilment marketplace device 104B. In another embodiment, the interface includes a note alerting user device 102 that a third-party seller will be shipping the item. At block 628, the user device 102 may preview the item via the interface received from the requesting marketplace device 104A.

If the user of user device 102 wishes to place the order, the user may direct user device 102 to place an order for the item using the interface received from requesting marketplace device 104A, at block 630. Requesting marketplace device 104A and mediating device 108 route the placed order request to the fulfilment marketplace device 104B using an active session token, at block 632.

The fulfilment marketplace device 104B may place the order and share order metadata, shipment details via an API to mediator device 108, at block 634. Mediator device 108 may process the order metadata response and send the placed order information to the requesting marketplace device 104A, at block 636. At block 638, the requesting marketplace device 104A may perform data transformation, update the order system, reporting, and generate a user interface to indicate that the order has been placed. The user interface may include order details including a confirmation number. At block 640, the user device 102 may view order fulfilment data on the user interface provided by the requesting marketplace device 104A.

Fulfilment marketplace device 104B may then process the order for shipment. Shipping and tracking information may be sent to the requesting marketplace device 104A and subsequently user device 102 when the ordered item is shipped. Fulfilment marketplace device 104B may ship the product to the shipping address of the user device 102. In another embodiment, the fulfilment marketplace device 104B may ship the product to requesting marketplace device 104A to ship to the user device 102.

Payment to the requesting marketplace device 104A from the user device 102 may occur at the time the order is placed. Remittance of the payment from the requesting marketplace device 104A to the fulfilment marketplace device 104B may occur at the time the order is placed. In other embodiments, the payment from the fulfilment marketplace device 104B is the amount the user device 102 sent to the requesting marketplace device 104A discounted by an agreed sharing percentage (or referral fee). The sharing percentage may be a percentage of the order or a flat amount. In another embodiment, payment from the requesting marketplace device 104A to the fulfilment marketplace device 104B may occur after the product is shipped to the user of user device 102, or after the item is received by the user of user device 102 (based on tracking information associated with the shipment of the item), or after a return period for the item has expired. The type of payment may include crypto currency, credit card, gift certificate/card to the requesting marketplace device 104A or fulfilment marketplace device 104B. In certain embodiments, execution of the smart contract can cause the transfer of currency from an account associated with user device 102 to the fulfilment marketplace device 104B (or requesting marketplace device 104A).

User device 102 may request to return the product. The return may be processed by the requesting marketplace device 104A. In other embodiments, the return may be processed by the fulfilment marketplace device 104B. The requesting marketplace device 104A may send a communication to the fulfilment marketplace device 104B (directly or through mediator device 108) with information describing the return request received from user device 102. Fulfilment marketplace device 104B may deny the request (for example, if the return time period has expired), or send return information to the requesting marketplace device 104A. Return information may include a return merchandise authorization (RMA) number, return shipping information, a shipping label. Charges may be reversed, or repayment made, less any applicable restocking, shipping fees, when the item is received by fulfilment marketplace device 104.

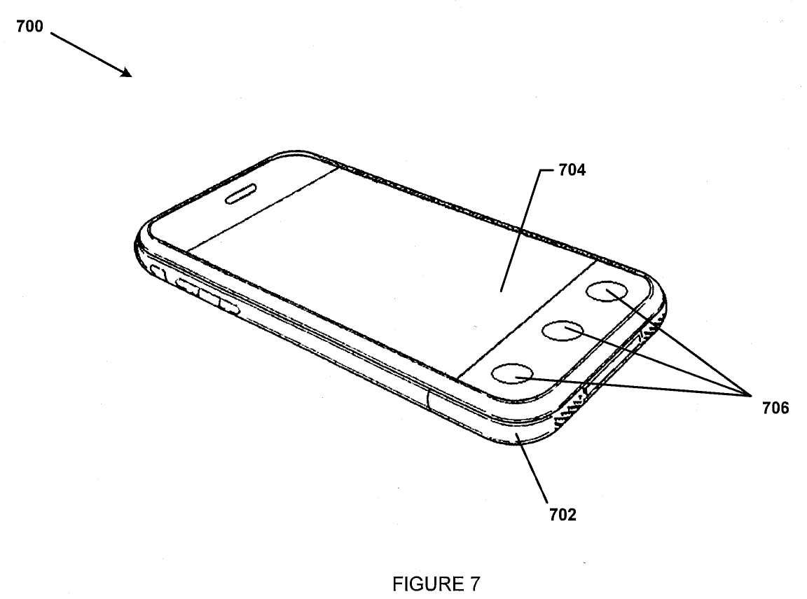

Referring now to FIG. 7, an embodiment of a user device 700 is illustrated. The device 700 may be any of the user devices discussed above. The device 700 includes a chassis 702 having a display 704 and an input device including the display 704 and a plurality of input buttons 706. One of skill in the art will recognize that the device 700 is a portable or mobile phone including a touch screen input device and a plurality of input buttons that allow the functionality discussed above with reference to methods 500 and 600. However, a variety of other portable/mobile devices and/or desktop devices may be used in methods 500 and 600 without departing from the scope of the present disclosure.

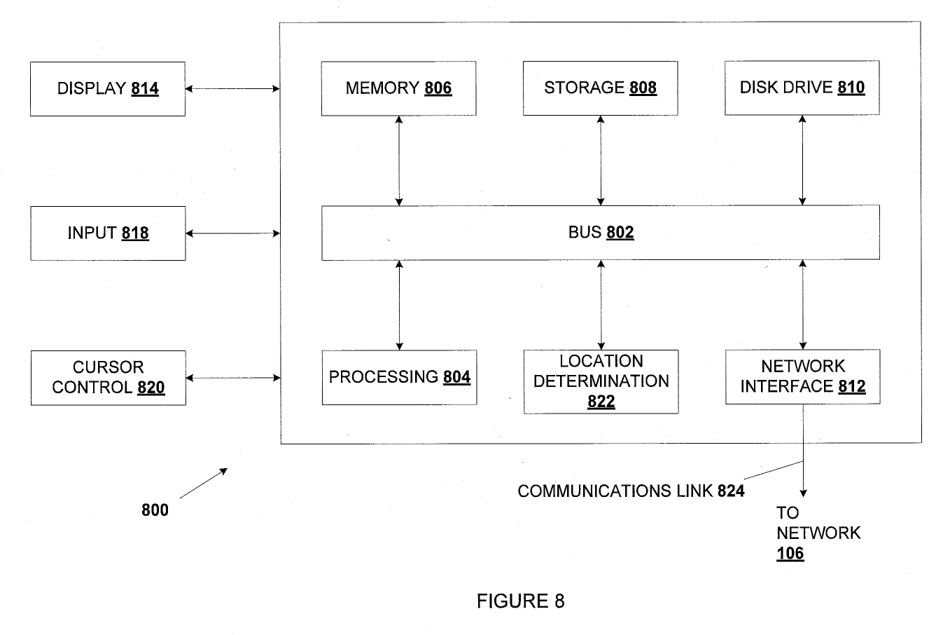

Referring now to FIG. 8, an embodiment of a computer system 800 suitable for implementing, for example, the user devices, distributed ledger devices, mediator devices and/or marketplace devices, is illustrated. It should be appreciated that other devices utilized in the adaptive product listing system may be implemented as the computer system 800 in a manner as follows.

In accordance with various embodiments of the present disclosure, computer system 800, such as a computer and/or a network server, includes a bus 802 or other communication mechanism for communicating information, which interconnects subsystems and components, such as a processing component 804 (e.g., processor, micro-controller, digital signal processor (DSP), etc.), a system memory component 806 (e.g., RAM), a static storage component 808 (e.g., ROM), a disk drive component 810 (e.g., magnetic or optical), a network interface component 812 (e.g., modem or Ethernet card), a display component 814 (e.g., CRT or LCD), an input component 818 (e.g., keyboard, keypad, or virtual keyboard), a cursor control component 820 (e.g., mouse, pointer, or trackball), and/or a location determination component 822 (e.g., a Global Positioning System (GPS) device as illustrated, a cell tower triangulation device, and/or a variety of other location determination devices known in the art). In one implementation, the disk drive component 810 may comprise a database having one or more disk drive components.

In accordance with embodiments of the present disclosure, the computer system 900 performs specific operations by the processor 804 executing one or more sequences of instructions contained in the memory component 806, such as described herein with respect to the payer devices, payee devices, user devices, payment service provider devices, and/or system provider devices. Such instructions may be read into the system memory component 806 from another computer readable medium, such as the static storage component 808 or the disk drive component 810. In other embodiments, hard-wired circuitry may be used in place of or in combination with software instructions to implement the present disclosure.

Logic may be encoded in a computer readable medium, which may refer to any medium that participates in providing instructions to the processor 804 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 810, volatile media includes dynamic memory, such as the system memory component 806, and transmission media includes coaxial cables, copper wire, and fiber optics, including wires that comprise the bus 802. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 800. In various other embodiments of the present disclosure, a plurality of the computer systems 800 coupled by a communication link 824 to the network 106 (e.g., such as a LAN, WLAN, PTSN, and/or various other wired or wireless networks, including telecommunications, mobile, and cellular phone networks) may perform instruction sequences to practice the present disclosure in coordination with one another.

The computer system 800 may transmit and receive messages, data, information and instructions, including one or more programs (i.e., application code) through the communication link 824 and the network interface component 812. The network interface component 812 may include an antenna, either separate or integrated, to enable transmission and reception via the communication link 824. Received program code may be executed by processor 804 as received and/or stored in disk drive component 810 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
at least one distributed ledger mining device, wherein each distributed ledger device comprises:
a first non-transitory memory; and
one or more first hardware processors coupled to the first non-transitory memory and configured to execute instructions from the first non-transitory memory to cause the distributed ledger mining device to perform operations comprising:
receiving at least one product inventory blockchain transaction broadcasted through a network by a fulfilment marketplace device and that includes product inventory information associated with a product that is provided by a fulfilment marketplace that controls the fulfilment marketplace device; and
adding each at least one product inventory blockchain transaction to a block in a product inventory distributed ledger such that product inventory information for the product provided by the fulfilment marketplace is stored in the product inventory distributed ledger; and
a requesting marketplace device, comprising:
a second non-transitory memory; and
one or more hardware processors coupled to the second non-transitory memory and configured to execute instructions from the second non-transitory memory to cause the requesting marketplace device to perform operations comprising:
receiving, through the network from a user device, a search query that includes a request for the product;
determining, in response to the request for the product in the search query, that the product is not available in a product inventory accessible to the requesting marketplace device;
accessing, in response to determining that the product is not available in the product inventory accessible to the requesting marketplace device, the product inventory distributed ledger;
identifying, via the product inventory information that is stored in the product inventory distributed ledger and that is associated with the product that is provided by the fulfilment marketplace, that the product is available from the fulfilment marketplace;
sending, through the network to the fulfilment marketplace device, a communication to fulfill the request for the product;
receiving, through the network from the fulfilment marketplace device, a response to the communication that includes at least one fulfilment term;
transmitting, through the network to the fulfilment marketplace device, an acceptance of the at least one fulfillment term;
the fulfilment marketplace device comprising:
a third non-transitory memory; and
one or more third hardware processors coupled to the third non-transitory memory and configured to execute instructions from the third non-transitory memory to cause the fulfilment marketplace device to perform operations comprising:
receiving, through the network from the requesting marketplace device, the acceptance of the at least one fulfilment term;
generating, in response to receiving the acceptance, a smart contract that includes the at least one fulfilment term; and
adding the smart contract to a fulfilment terms distributed ledger, wherein the smart contract is configured to execute to cause a modification of the product inventory information for the product provided by the fulfilment marketplace.

2. The system of claim 1, wherein the operations performed by the requesting marketplace device further comprise:
transmitting, to the user device, an item preview interface that includes the at least one fulfilment term received from the fulfilment marketplace device;
receiving, from the user device, an order request for the product;
receiving a confirmation of the acceptance of the at least one fulfilment term from the fulfilment marketplace device; and
transmitting, in response to receiving the confirmation of the acceptance, an order fulfillment interface to the user device.

3. The system of claim 1, wherein the communication to fulfill the request for the product is sent via a first tokenized communication, the response to the communication is sent via a second tokenized communication, and the acceptance of the at least one fulfillment term is sent via a third tokenized communication.

4. The system of claim 1, wherein the user device is also a party to the smart contract.

5. The system of claim 4, wherein the smart contract further includes:
a payment term, and wherein the smart contract is configured to execute to cause a currency to be transferred from an account associated with the user device.

6. The system of claim 1, wherein the operations performed by the requesting marketplace device further comprise:
receiving, through the network from the user device, an order request.

7. The system of claim 6, wherein the at least one fulfillment term is accepted in response to receiving the order request from the user device.

8. A method comprising:
receiving, by a distributed ledger mining device, at least one product inventory blockchain transaction that was broadcast through a network by a fulfilment marketplace device and that includes product inventory information associated with a product that is provided by a fulfilment marketplace that controls the fulfilment marketplace device;
adding, by the distributed ledger mining device, each at least one product inventory blockchain transaction to a block in a product inventory distributed ledger such that product inventory information for the product provided by the fulfilment marketplace is stored in the product inventory distributed ledger;
receiving, by a requesting marketplace device through the network from a user device, a search query that includes a request for the product;
determining, by the requesting marketplace device in response to the request for the product in the search query, that the product is not available in a product inventory accessible to the requesting marketplace device;
accessing, by the requesting marketplace device in response to determining that the product is not available in the product inventory accessible to the requesting marketplace device, the product inventory distributed ledger;
identifying, by the requesting marketplace device via the product inventory information that is stored in the product inventory distributed ledger and that is associated with the product that is provided by the fulfilment marketplace, that the product is available from the fulfilment marketplace;
sending, by the requesting marketplace device through the network to the fulfilment marketplace device, a communication to fulfill the request for the product;
receiving, by the requesting marketplace device through the network from the fulfilment marketplace device, a response to the communication that includes at least one fulfilment term;
transmitting, by the requesting marketplace device through the network to the fulfilment marketplace device, an acceptance of the at least one fulfillment term;
receiving, by the fulfilment marketplace device through the network from the requesting marketplace device, the acceptance of the at least one fulfilment term;
generating, by the fulfilment marketplace device in response to receiving the acceptance, a smart contract that includes the at least one fulfilment term; and
adding, by the fulfilment marketplace device, the smart contract to a fulfilment terms distributed ledger, wherein the smart contract is configured to execute to cause a modification of the product inventory information for the product provided by the fulfilment marketplace.

9. The method of claim 8, wherein the sending the communication to fulfill the request for the product comprises sending the communication to fulfill the request for the product to a mediating entity device instructing the mediating entity device to broadcast the query to a plurality of online marketplace devices including the fulfilment marketplace device.

10. The method of claim 8, wherein transmitting the order request, by the requesting marketplace device, to the fulfilment marketplace device comprises using an active session token to authenticate and verify participants.

11. The method of claim 10, wherein the communication to fulfill the request for the product comprises an application programming interface (API) request from the requesting marketplace device to the fulfilment marketplace device.

12. The method of claim 10, wherein communication to fulfill the request for the product to the fulfilment marketplace device uses the active session token between the requesting marketplace device and the fulfilment marketplace device.

13. The method of claim 8, further comprising transmitting, from the requesting marketplace device to the user device, an item preview interface that includes the at least one fulfilment term received from the fulfilment marketplace device, wherein the item preview interface does not inform the user device that the product is not available in a product inventory accessible to the requesting marketplace device at the requesting marketplace device and would be fulfilled by the fulfilment marketplace.

14. The method of claim 8, wherein the communication to fulfill the request for the product comprises at least one of: identification of the requesting marketplace that controls the requesting marketplace device, identification of the product, a user identifier, a shipping address, a transaction currency, or a shortest shipping timespan to the shipping address.

15. The method of claim 8, wherein the at least one fulfilment term comprises at least one of: identification of the fulfilment marketplace, identification of the product, a shipping address, a shipping timespan, a transaction currency, a shipping cost, a product cost, or a profit sharing margin.

16. The method of claim 8, wherein the smart contract comprises payment terms, shipping terms, and a share of a payment to a requesting marketplace that controls the requesting marketplace device.

17. The method of claim 8, wherein the fulfilment terms distributed ledger is a public blockchain, and data from the smart contract is copied from the public blockchain to a consortium blockchain, and wherein members of the consortium blockchain include a requesting marketplace that controls the requesting marketplace device and the fulfillment marketplace.

18. The method of claim 8, wherein:
the distributed ledger comprises a consortium blockchain, and
the one or more hardware processors coupled to the non-transitory memory and configured to read instructions from the non-transitory memory to cause the system to perform operations further comprises: determining the inventory of the product at the fulfilment marketplace based on entries in the consortium blockchain and wherein members of the consortium blockchain comprise the requesting marketplace device and the one or more online marketplace devices.

19. A method comprising:
receiving, by a distributed ledger mining device, at least one product inventory blockchain transaction that was broadcast through a network by a fulfilment marketplace device and that includes product inventory information associated with a product that is provided by a fulfilment marketplace that controls the fulfilment marketplace device;
adding, by the distributed ledger mining device, each at least one product inventory blockchain transaction to a block in a product inventory distributed ledger such that product inventory information for the product provided by the fulfilment marketplace is stored in the product inventory distributed ledger;
receiving, by the fulfilment marketplace device through the network from the requesting marketplace device, a communication to fulfill a request for the product;
sending, by the fulfilment marketplace device through the network to the requesting marketplace device, a response to the communication that includes at least one fulfilment term;
receiving, by the fulfilment marketplace device through the network from the requesting marketplace device, an acceptance of the at least one fulfilment term;
generating, by the fulfilment marketplace device in response to receiving the acceptance, a smart contract that includes the at least one fulfilment term; and
adding, by the fulfilment marketplace device, the smart contract to a fulfilment terms distributed ledger, wherein the smart contract is configured to execute to cause a modification of the product inventory information for the product provided by the fulfilment marketplace.

20. The method of claim 19, wherein the at least one fulfilment term comprises at least one of: identification of the fulfilment marketplace, identification of the product, a shipping address, a shipping timespan, a transaction currency, a shipping cost, a product cost, or a profit sharing margin.
